(19) United States
(12) Patent Application Publication
(10) Pub. No.: US 2015/0066974 A1
(43) Pub. Date: Mar. 5, 2015

(54) METHOD, SYSTEM AND COMPUTER-READABLE MEDIUM FOR SEARCHING ICD CODES LINKED TO HIERARCHICALLY ORGANIZED KEYWORDS THAT ARE APPLIED TO A STANDARDS-BASED VOCABULARY

(71) Applicant: e-MDs, Inc., Cedar Park, TX (US)

(72) Inventor: David WINN, Lago Vista, TX (US)

(21) Appl. No.: 14/471,596

(22) Filed: Aug. 28, 2014

Related U.S. Application Data
(60) Provisional application No. 61/871,033, filed on Aug. 28, 2013.

(51) Int. Cl. G06F 17/30; G06F 3/0484

(52) U.S. Cl. CPC G06F 17/30392; G06F 3/04842
USPC 707/766

(57) ABSTRACT

A stand-alone web-based rapid anatomical documentation (RAD) system searches for ICD codes linked to key words that are applied to a standards-based structured vocabulary. The RAD system provides a search screen divided into a plurality of display regions for selecting a search type from the search screen. The search type includes a text search and anatomy search. Based on the type of search initialed, search filters and ICD codes are made available. Selecting at least one search filter causes an update of the search filters and ICD codes available, wherein the selection of the search filters can be repeated until a number of codes available reach a minimum value. Each ICD code is linked to keywords hierarchically organized and associated with the search filters, links to defined regions on anatomical art images and clinically relevant information.

### FIELD OF THE INVENTION

The present invention relates to a stand-alone web-based system and method that allows a user to click on areas of anatomical art or enter text, which in turn, searches for ICD codes, which are linked to key words that are applied to a standards-based structured vocabulary.

### BACKGROUND OF THE INVENTION

1. Description of the Related Art

Common diagnostic and service codes have been developed to simplify or standardize the requirements for payment to physicians and other health care service providers for their services by third party payers (e.g., private insurance carriers or government programs such as the Medicare and/or Medicaid programs). Errors or noncompliance with these reporting requirements can result in a denial of or delay in payment for services.

These codes have been developed primarily by the Health Care Financing Administration (HCFA) of the U.S. government, and the American Medical Association (AMA). The codes selected by HCFA are referred to as the International Classification of Diseases (ICD) codes.

The ICD codes are often used in combination with medical standard vocabularies, which provides a textual description of a condition and code (e.g., ICD) associated with that condition.

Failure to provide the proper codes usually results in an initial denial of payment and a significant delay in the billing and the collection process. However, using the latest revisions of the ICD codes such as ICD-10 can be difficult because the number of codes (including both diagnosis and procedure codes) increase from roughly 18,000 to 153,000 codes between ICD-9 and ICD-10.

Thus, it is desirable to reduce the time and effort required for searching for the latest version of the ICD codes such as ICD-10.

### SUMMARY OF THE INVENTION

The present invention includes embodiments for a method, system and computer-readable medium for searching for International Classification of Diseases (ICD) codes using a stand-alone web-based Rapid Anatomical Documentation (RAD) tool.

Access to the RAD system is provided via a dedicated website and after proper authentication is provided via, for example, a username and password. Upon accessing the RAD system, a user interface (UI) for launching an RAD tool is provided within the RAD system environment and is presented as a home page.

From the home page for the RAD tool, previously saved search results can be accessed or a search for an ICD code can be initiated by launching the RAD tool. Once the RAD tool is launched, a search screen divided into a plurality of display regions including a location section, a diagnoses section and an ICD code section is presented.

The search screen allows the initiation of a text search or an anatomy search. The screen can toggle between the text search and the anatomy search by clicking a button within the RAD tool environment. When a search type is initiated, the available search filters in the location section and the diagnoses section and available ICD codes in the code section based on the entered search request are provided.

The selecting of at least one search filter from the location section or the diagnoses section causes an update of the search filters and ICD codes available in the code section. More than one filter can be selected at a time and the selection of the search filters is repeatable so that the number of codes available in the codes section can be filtered to a minimum value.

The ICD codes include ICD-10 codes and each ICD code is linked to keywords hierarchically organized and associated with the search filters, links to defined regions on anatomical art images and clinically relevant information. The result of a search can be saved, which saves the selected ICD code and the clinically relevant information. The clinically relevant information based on the code selected includes, for example, but not limited to, doctor orders, procedures, medications and billing information.

Additionally, the saving of the search saves search terms used, the search filters selected and codes returned and selected in association with a user account associated with the search request. The saved search is viewable at a future time when launching the RAD tool within the RAD system environment in association with the user account. The saving of search results further includes pasting a URL into a messaging application or a patient's chart.

The RAD system is a stand-alone web-based system for searching for ICD codes that includes a network interface for allowing access to the RAD system after authentication is performed; an RAD application system including the UI for launching the RAD tool within an RAD system environment; a database in communication with the RAD application system for storing and providing information related to search terms, codes, orders, billing information and user account information; and an editor in communication with the RAD application system for providing information to the RAD application system regarding a link between each ICD code searched and keywords hierarchically organized and associated with the search filters, links to anatomical art and clinically relevant information.

The editor is configured to link the ICD codes to keywords, organize the keywords in hierarchies for creating keyword trees and group the keyword hierarchies. The keywords are also associated with links to defined regions on anatomical art images displayed in the location section when conducting an anatomy search, and the keywords are associated with text used for conducting the text search.

The editor is configured to divide keywords into location and diagnosis-type, and categorize the keywords into location and diagnosis-type hierarchies, and link specific location keywords with custom-defined regions of anatomical art images. The present invention provides an RAD tool for performing very fast ICD-10 search results.

The SUMMARY OF THE INVENTION is provided as an introduction to the invention based on a simplified explanation. The invention is described in more detail in the DETAILED DESCRIPTION OF THE INVENTION. The SUMMARY OF THE INVENTION is not meant to identify every key features or essential element of the invention, and is it intended to be used to limit the scope of the claimed invention.

### BRIEF DESCRIPTION OF THE DRAWINGS

In the drawings, like reference numbers generally indicate identical, functionally similar and/or structurally similar elements. Embodiments of the invention will be described with reference to the accompanying drawings, wherein:

FIG. 1 is a flowchart that illustrates a process of using the RAD tool to search for codes in accordance with an embodiment of the invention;

FIGS. 2 and 3 illustrate screen shots of the login and home page respectively for the RAD tool in accordance with an embodiment of the invention;

FIGS. 4 and 5 illustrate screen shots of the search screens in accordance with an embodiments of the invention;

FIG. 6 illustrates a screen shot of another search screen for providing additional information regarding a selected code in accordance with an embodiment of the invention;

FIG. 7 illustrates a screen shot of the orders screen when the orders tab is selected in accordance with an embodiment of the invention;

FIG. 8 illustrates a screen shot of a screen when the superbill tab is selected in accordance with an embodiment of the invention;

FIGS. 9-11 illustrate screen shots of the search screens for an anatomy search in accordance with an embodiments of the invention; and

FIGS. 12 illustrate a screen shot of a search screen for a text search in accordance with an embodiment of the present invention;

FIG. 13 is a conceptual systems diagram of the RAD system in accordance with an embodiment of the present invention;

FIGS. 14 and 15 illustrate operations performed by the editor in accordance with an embodiment of the present invention;

FIG. 16 is a block diagram of the RAD application system in accordance with an embodiment of the present invention; and

FIG. 17 is a block diagram of the editor in accordance with an embodiment of the present invention.

Additional features are described herein, and will be apparent from the following description of the figures.

### DETAILED DESCRIPTION OF THE INVENTION

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring the description of the invention.

In the drawings accompanying the description that follows, often both reference numerals and legends (labels, text descriptions) may be used to identify elements. If legends are provided, they are intended merely as an aid to the reader, and should not in any way be interpreted as limiting the scope of the invention.

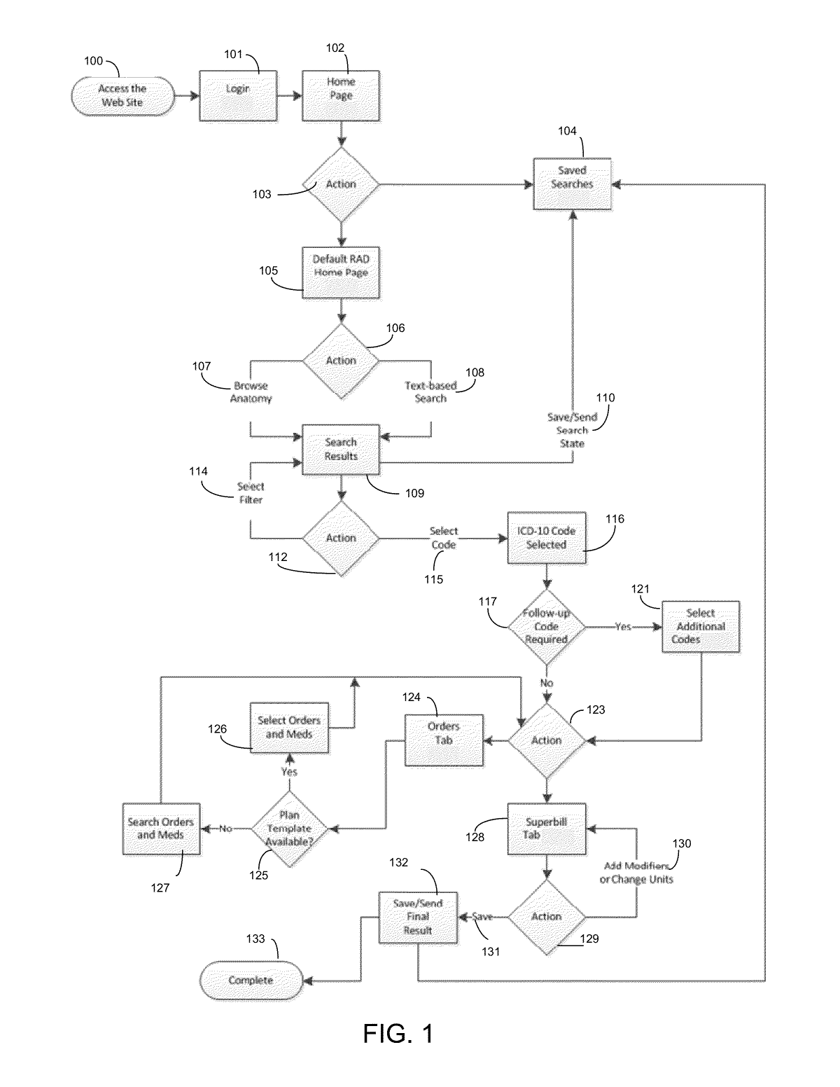

FIG. 1 illustrates a process of using the Rapid Anatomical Documentation (RAD) tool within the RAD system to search for ICD codes in accordance with an embodiment of the invention. The explanation of FIG. 1 will be provided along with reference to other figures illustrating screen shots of what a typical user is viewing in order to aid in the understanding of the invention.

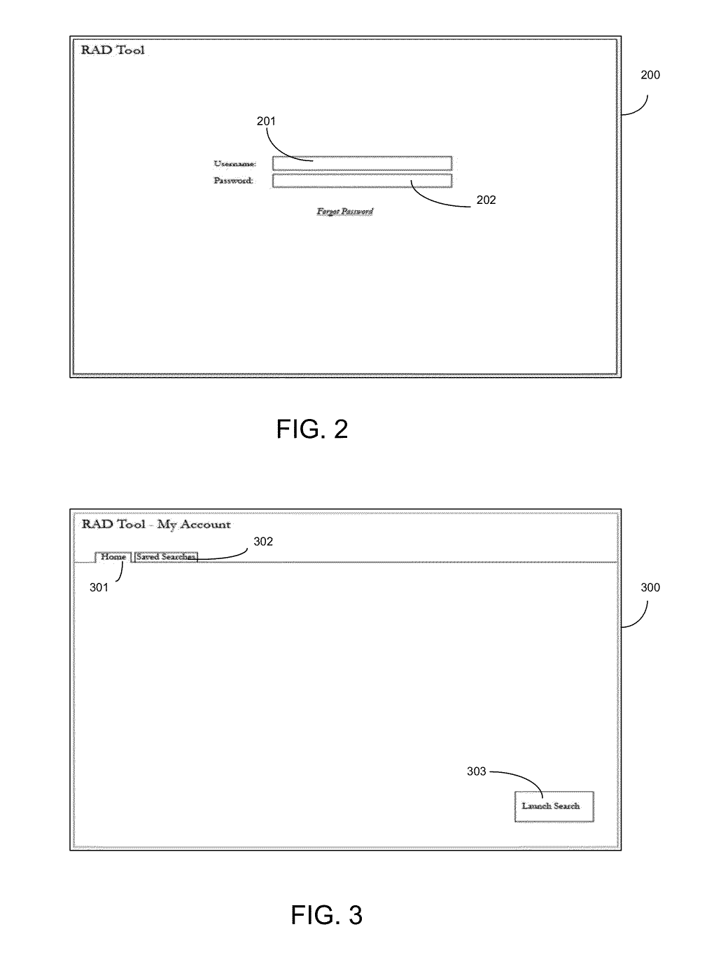

As shown at the top of FIG. 1, access to the RAD tool is provided at step 100 either directly through a hyperlink (e.g., dedicated website) or as a service embedded in another website. At step 101, a login screen is provided, which requires authentication by entering a username and password. FIG. 2 illustrates a screen shot of the login screen 200, which includes corresponding fields 201 and 202 for entering a user name and password.

Once authentication is complete, a home page for the RAD tool is provided in step 102. FIG. 3 illustrates the home page 300 for the RAD tool that is presented after a successful login by a user. As shown in FIG. 3, a user will see tabs 301 and 302. The home tab 301 will show the user information about their account as well as a “Launch Search” button 303 for launching a search using the RAD tool.

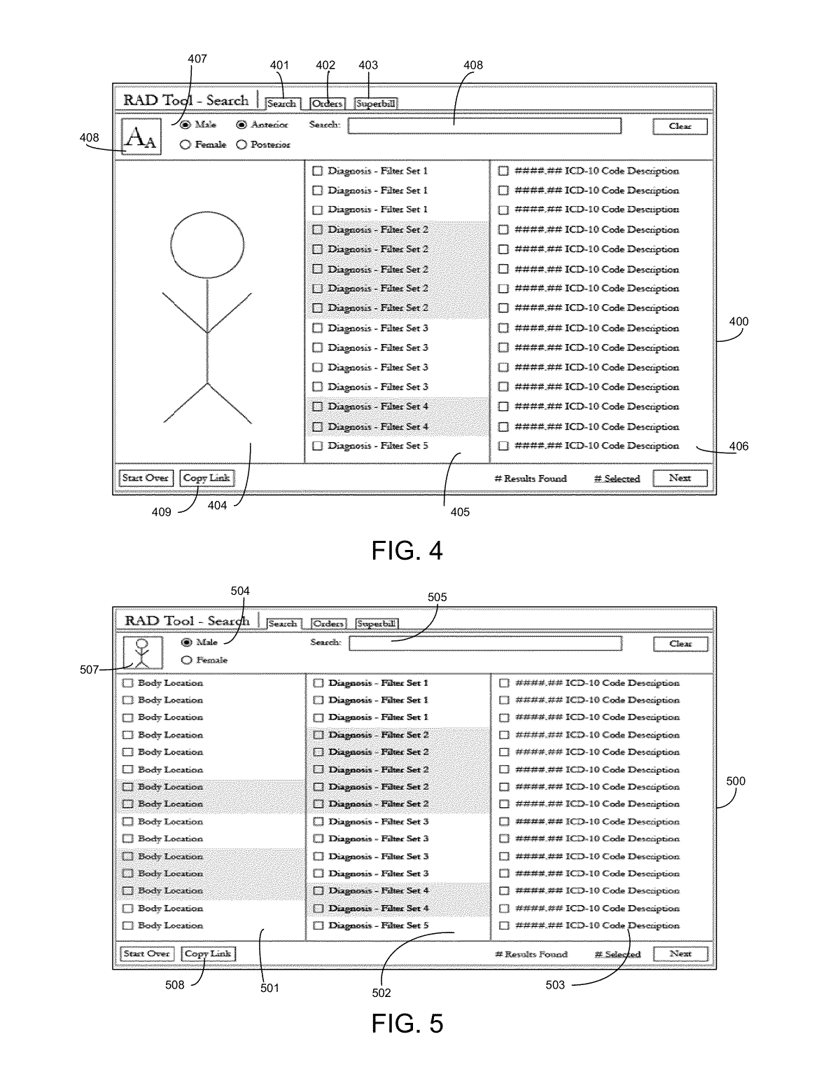

In step 103, the user either takes an action to access saved searches to see previously searched ICD codes in step 104 or access a default search home page in step 105. FIG. 4 illustrates a screen shot of the default home page 400. As shown in FIG. 4, the default home page 400 includes three tabs: 1) search tab 401; 2) orders tab 402; 3) and superbill tab 403. The search tab 401 is the primary function within the RAD tool. A user can search via either using an anatomical art image of the human anatomy (i.e., anatomy search) or text search. The orders tab 402 shows orders related to the ICD code that has been selected; and the superbill tab 403 is summary of ICD codes and orders and their linkage is shown on this tab.

In step 106, the user can initiate either the anatomy search in step 107 or the text search in step 108. FIG. 4 shows that anatomy search as the default setting in the default home page 400. As shown in FIG. 4, the search screen is divided into a plurality of display regions including a location section 404, a diagnoses section 405 and an ICD code section 406. FIG. 5 is an example of the search screen 500 when the text search is initiated in step 108. Similar to the anatomy search, the search screen for the text search 500 is divided into a plurality of display regions including a location section 501, a diagnoses section 502 and an ICD code section 503.

As shown in FIGS. 4 and 5, additional selections can be made in order to narrow the search criteria. For example, in FIG. 4, the additional selections, when in the anatomy search, are located on the bar 407 above the display regions and include a gender selection (i.e., male or female) and an orientation selection (i.e., anterior and posterior). The orientation selection is only available when initiating an anatomy search. In FIG. 5, the additional selections, when in the text search, are located on the bar 504 above the display regions and include a gender selection (i.e., male or female).

Both FIGS. 4 and 5 also include search fields 408, 505 for entering text. When text is entered the locations, diagnoses, and ICD codes sections are updated based on the search results. Additionally, both FIGS. 4 and 5 include an anatomy/text switch button 408, 507 that allows the user to toggle between the different types of searches (i.e., anatomy and text searches). For example, anatomy/text switch button 408, 507 can change the leftmost location section 404, 501 from an anatomical image based selector to a filter list, as shown in FIG. 5 (e.g., similar to the diagnoses filters in the diagnoses section 502).

In step 109, the search results are returned based on the type of search selected in steps 107 or 108. Based on the search initiated in steps 107 or 108, the filters displayed are updated based on the region of the anatomy selected or text entered. Additionally, the code section displays ICD-10 codes, which are also updated to show results based on text entered or selected region of the anatomy and the selected filters in the anatomy and diagnoses sections.

In step 110, the search results returned in step 109 can be saved and accessed later to see previously searched ICD codes for a particular search. This action is taken by selecting the “Copy Link” button 409, 508, which saves the state of the display (e.g., any searched-for terms, filters selected, and ICD codes selected). Additionally, a hyperlink is also copied to a clipboard for the user to paste to a location (e.g., into a messaging application or a patient's chart note). This saved search will also be shown in the user's saved searches (accesses by the “Saved Searches” tab 302) when logging into the RAD system at a later date.

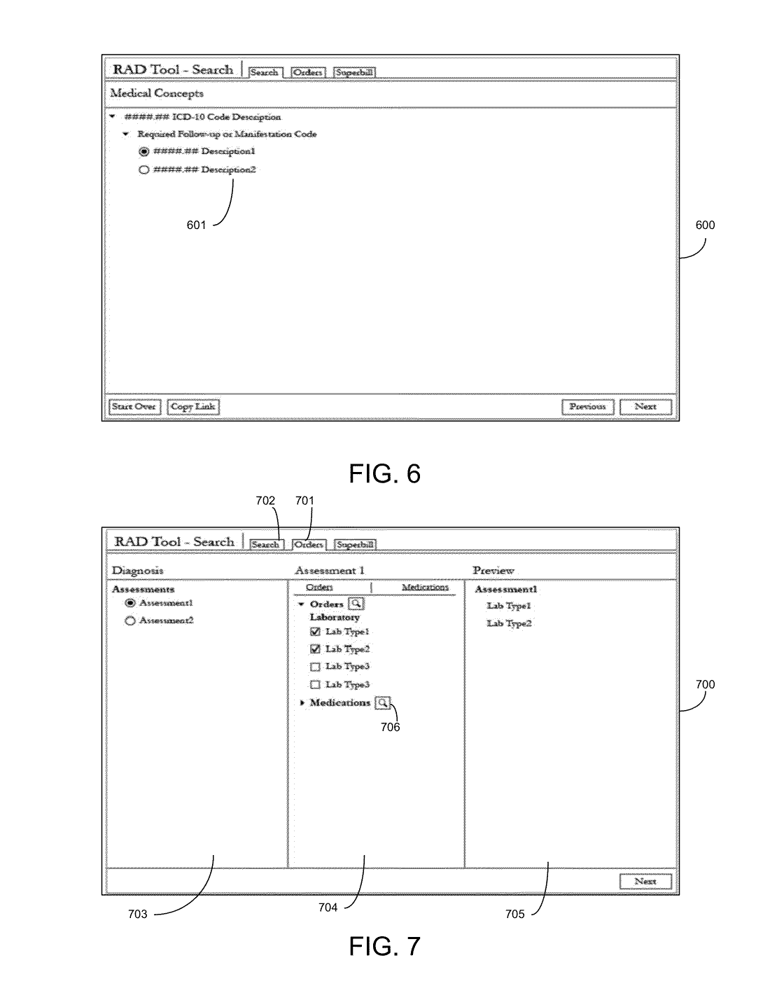

In step 112, action can be taken to either select another filter to narrow the search results in step 114 or, if the search results are satisfactory, select an ICD-10 code listed in the code section. The filters and ICD codes can be selected or de-selected by clicking the box of the corresponding filters and ICD codes. Once a user is satisfied with the search results, in steps 115 and 116, an ICD-10 is selected. In step 117, it is determined if any additional information is required for the ICD code selected. If additional information is required for the code selected, then in step 121 a screen is presented for selecting additional codes. FIG. 6 is a screen shot of the type of screen that is displayed for making a selection of additional codes for the ICD code selected.

As shown in FIG. 6, if the selected code requires additional information, the user is presented with a search screen 600 having required fields 601 for selecting additional codes before moving to the orders and superbill tabs. An example of a required code would be smoking history for a patient diagnosed with lung cancer.

Once the additional codes are selected in step 121 or if no additional codes are required at step 117, action can then be taken at step 123 to proceed to the orders tab, and in step 124, the process proceeds to the orders tab. FIG. 7 is an exemplary screen shot of the screen associate with the selection of the orders tab. As shown in FIG. 7, screen 700 associated with the orders tab 701 displays orders that are considered best practices for the diagnosis codes selected from the search tab 702. The screen 700 is divided into “Diagnosis” 703, “Assessment” 704 and “Preview” 705 regions.

In step 125, it is determined if there is an order plan in place for the patient. If there is no plan in place, in step 127 the orders and medication are searched. If it is determined that there is an order plan in place for the patient in step 125, then in step 126 the orders and medications are selected from the plan. As shown in FIG. 7, as orders are selected in section 704 they are shown in detail on the rightmost column 705 and shown as associated with the selected assessment (e.g., “Assessment 1”) in section 703. From within the screen associated with the orders tab, a user can select a link 706 in order to review the details of any medications that are being taken by a patient.

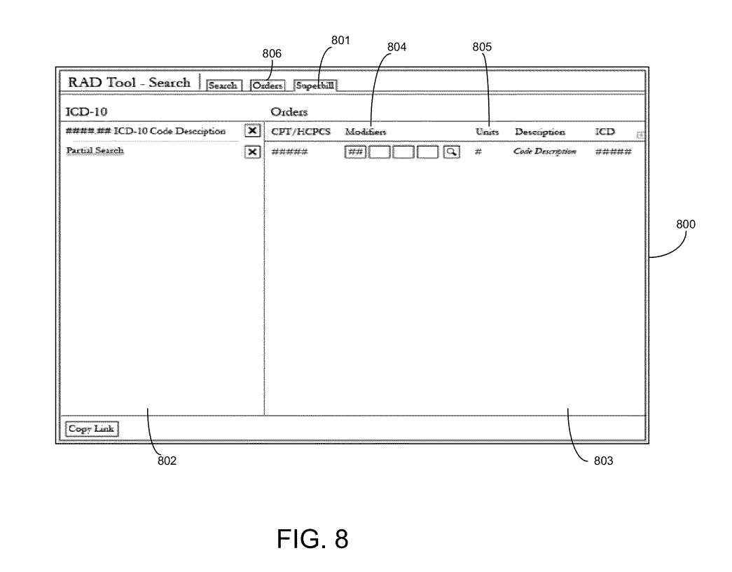

In step 128, the process proceeds to the superbill tab. An exemplary screen shot of the screen associated with the superbill tab is shown in FIG. 8. As shown in FIG. 8, the screen 800 associated with the superbill tab 801 shows the user what codes and orders have been selected. The screen 800 is divided into “ICD-10” codes section 802 and “Orders” section 803. Within the screen 800 associated with the superbill tab 801, the user can also add modifier codes 804 or change the number of units 805 needed for the selected order from the orders tab 806.

In step 129, action can be taken to add modifier codes 804 or change the number of units 805 needed for the selected order, which is completed in step 130. Once the modifier codes and/or the number of units are changed, or if it is not necessary to add modifier codes or change the number of units, then in steps 131 and 132, the user can save the search results and selected orders, or send the results as a superbill to another user. The final saved search will be listed (e.g., in a grid format) among the user's saved searches (accesses by the “Saved Searches” tab 302) when logging into the RAD system at a later date. Once the final results of the search are saved, the process is complete at step 133 and the user has the option of logging off the RAD system.

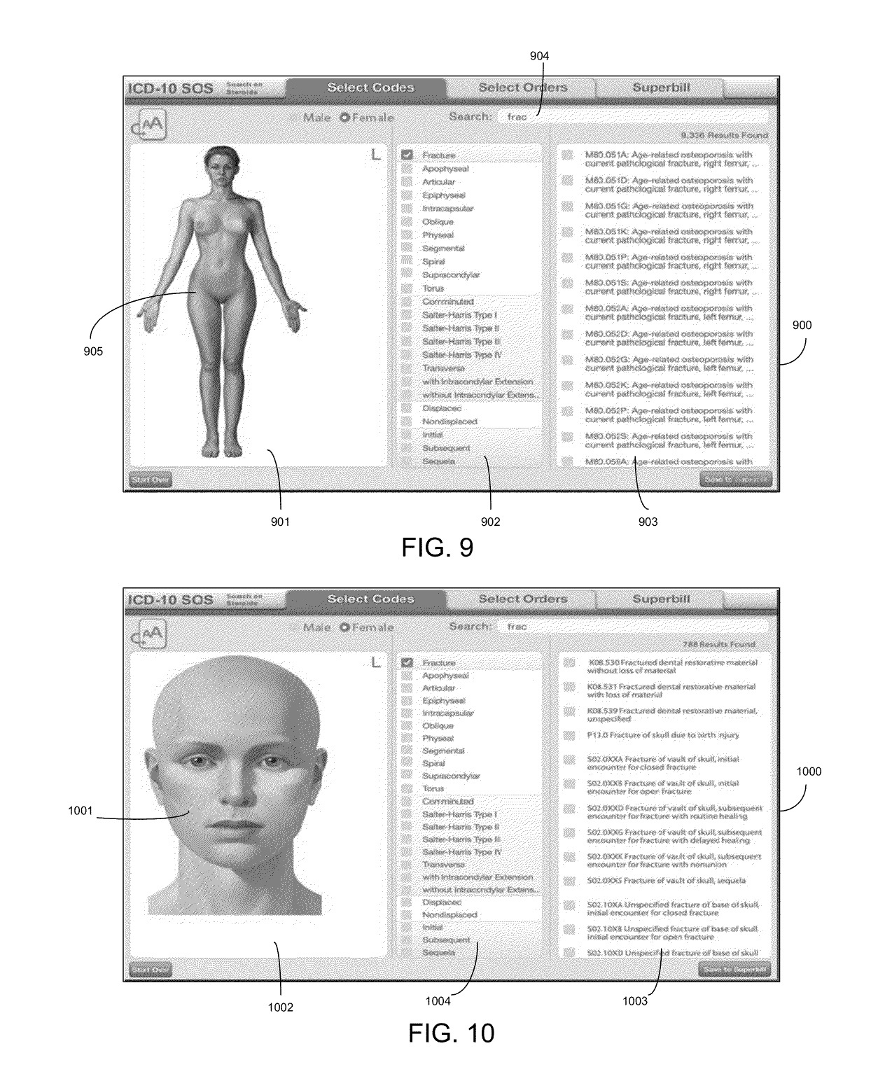

FIGS. 9-11 illustrate screen shots of the search screens for an anatomy search in accordance with embodiments of the invention. As shown in FIG. 9, the search screen 900 is divided into display regions including a location section 901, a diagnoses section 902 and an ICD code section 903. In location section 901, an anatomical art image of a female is selected based on a gender selection of “female” and an “anterior” orientation selection by the user. FIG. 9 shows that the text search term of “frac” was entered in the search field 904, which, in turn, resulted in the filters and ICD codes being listed in the corresponding diagnoses section 902 and an ICD code section 903.

The screen 1000 in FIG. 10 shows that the user has selected the head region of the anatomical art image 905, which resulted in the head region 101 being shown in an enlarge view of the location section 1002 of the screen 1000. Displaying an enlarged view of the selected region results will update the filters shown in the diagnoses section 1004 and the ICD codes being shown in the code section 1003.

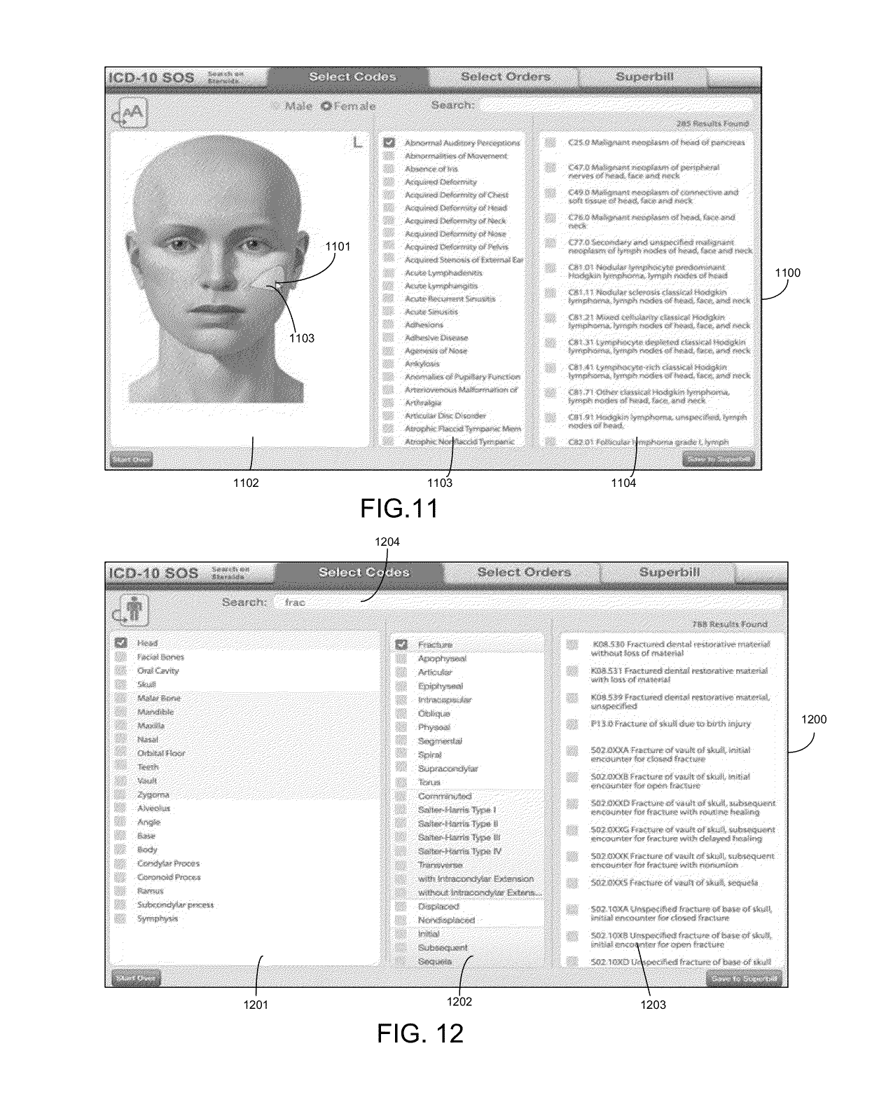

FIG. 11 illustrates a screen shot of the search screens for an anatomy search. As shown in FIG. 11, when the user's cursor 1101 is over an anatomical location in the location section 1102, the location or region 1103 of the anatomy is highlighted. This indicates which location will be “drilled down” when it is clicked. The filters in the diagnoses section 1103 and ICD-10 in the code section 1104 will be updated based on the selected body location.

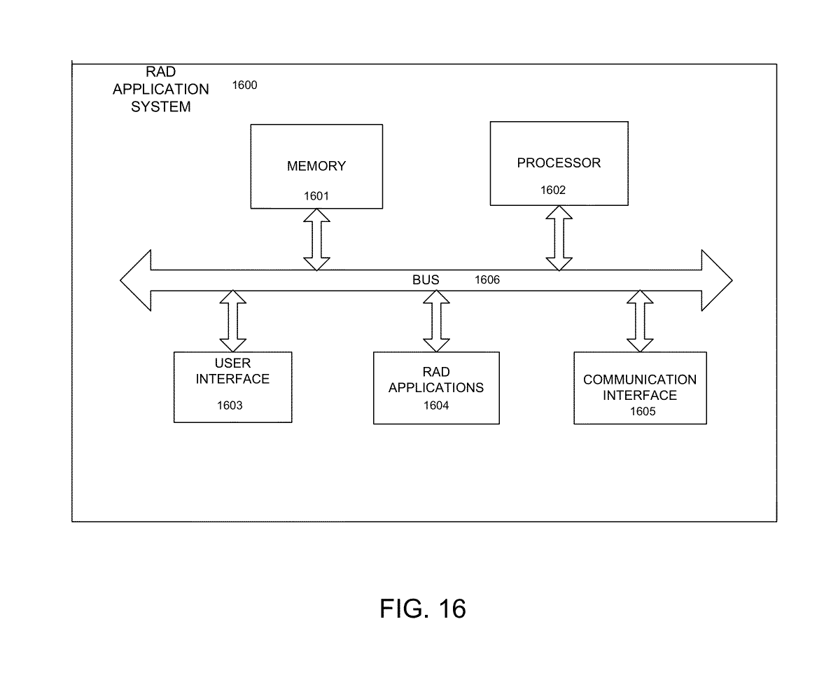

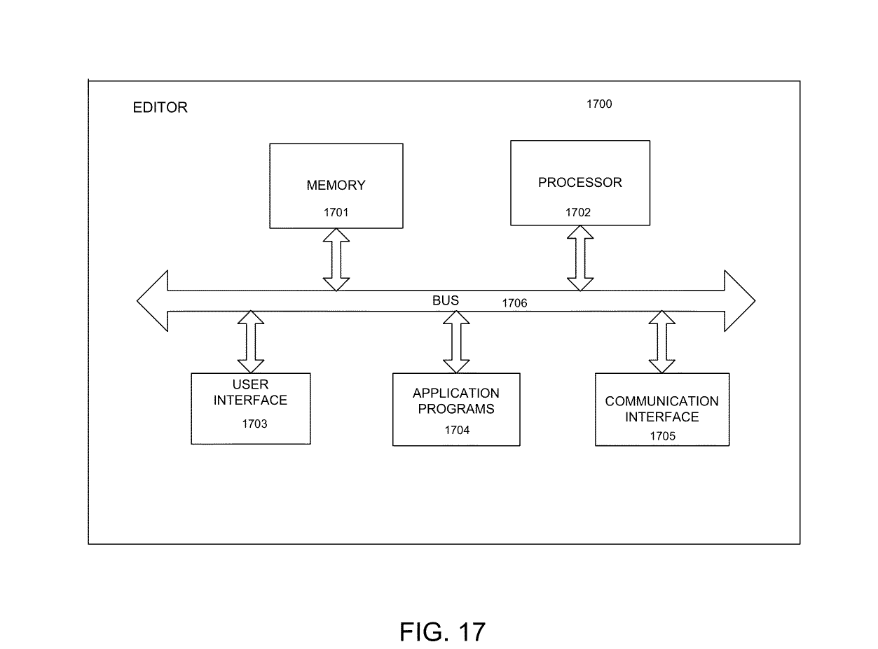

FIG. 12 illustrates a screen shot of a search screen for a text search in accordance with an embodiment of the present invention. As shown in FIG. 12, the search screen 1200 is divided into display regions including a location section 1201, a diagnoses section 1202 and an ICD code section 1203. In location section 1201, location filters are listed of which “head” is selected. FIG. 12 shows that the text search term of “frac” was entered in the search field 1204. Based on the search criteria, filters and ICD codes are listed in the corresponding diagnoses section 1202 and an ICD code section 1203. The ICD codes listed in the code section 1203 are linked to keywords, the keywords are organized into hierarchies for creating keyword trees and group the keyword hierarchies. The keywords are associated with links to defined regions on anatomical art images displayed in the location section 1001. The links regarding the ICD codes and keywords will be explained in more detail later with reference to FIGS. 16 and 17.

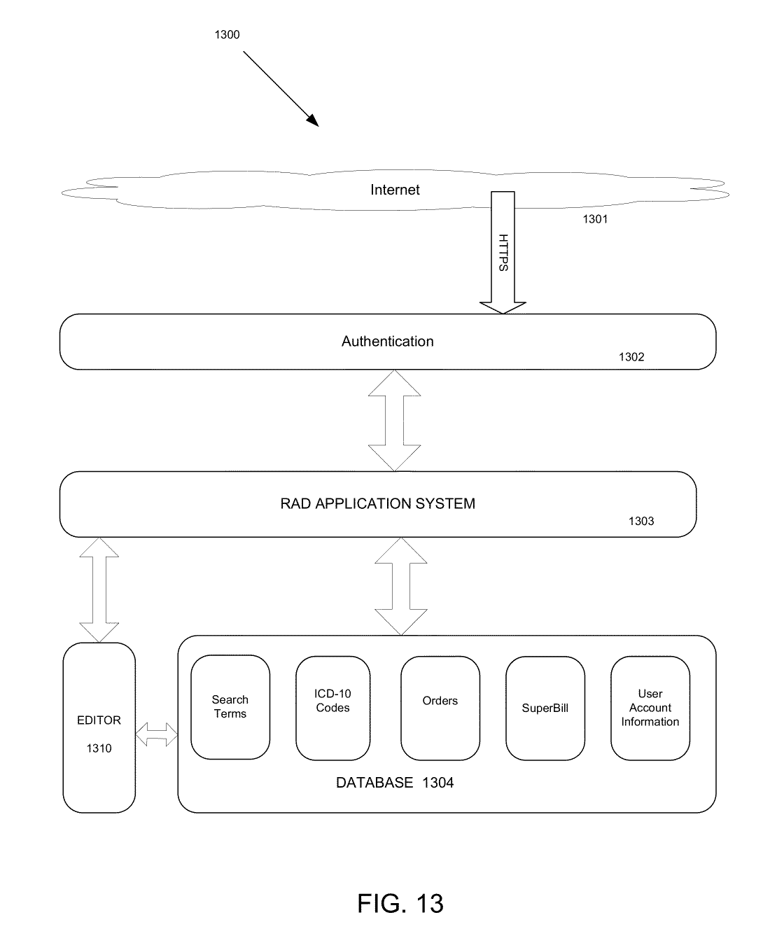

FIG. 13 is a conceptual systems diagram of the RAD system in accordance with an embodiment of the present invention. In FIG. 13, the RAD system 1300 is a stand-alone web-based system for searching for ICD codes. Access to the RAD system 1300 is provided via a dedicated website via the Internet 1301. Access to the RAD application system 1303 requires authentication 1302, for example, by using a username and password. Upon accessing the RAD application system 1303, a user interface (UI) for launching an RAD tool for searching ICD codes is provided within the RAD system environment and is presented as a home page.

A database 1304 is in communication with the RAD application system 1303 for storing and providing information related to search terms, codes, patient orders, billing information and user account information. Additionally, an editor 1310 is in communication with the RAD application system 1303 and the database 1304 for providing information to the RAD application system 1303 regarding a link between each ICD code searched and keywords hierarchically organized and associated with the search filters, links to anatomical art and clinically relevant information.

The editor 1310 is configured to link the ICD codes to keywords, organize the keywords in hierarchies for creating keyword trees and group the keyword hierarchies. The keywords are also associated with links to defined regions on anatomical art images displayed in the location section when conducting an anatomy search, and the keywords are associated with text used for conducting the text search.

The editor is configured to divide keywords into location and diagnosis-type, and categorize the keywords into location and diagnosis-type hierarchies, and link specific location keywords with custom-defined regions of anatomical art images. The present invention provides an RAD tool for performing very fast ICD-10 search results.

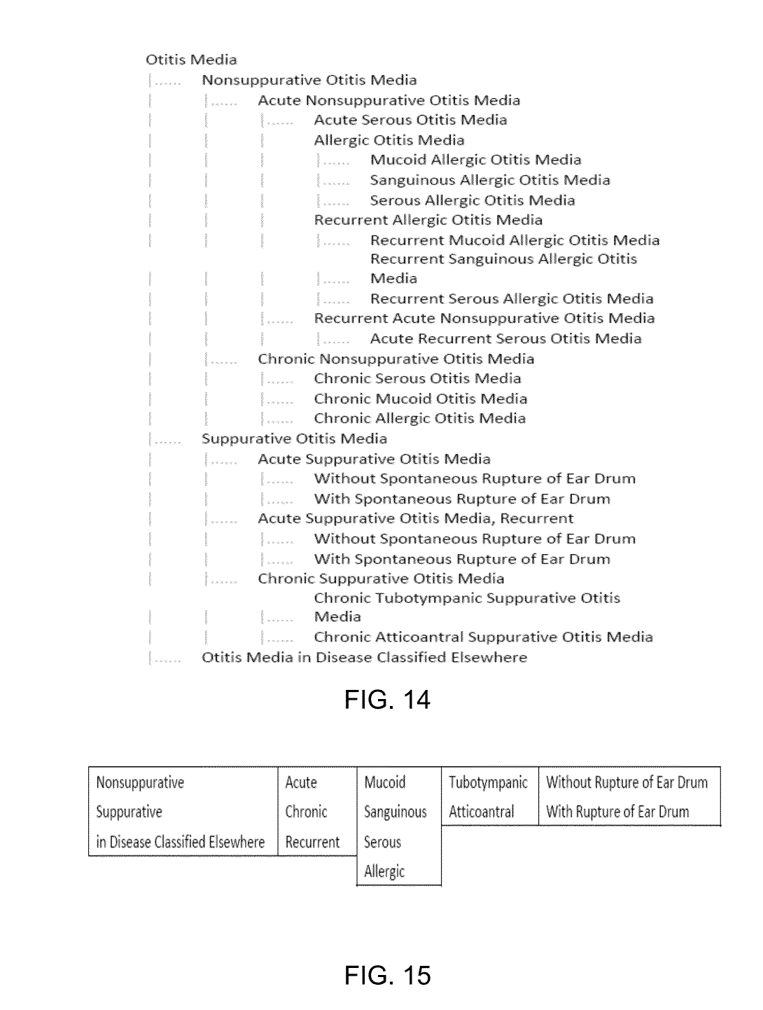

Operation of the editor 1310 is described in more detail with reference to FIGS. 14 and 15. The editor 1310 deconstructs ICD-10 descriptions into atomic bits of information, or keywords, which are divided into location and diagnosis-type. This data is what drives the information presented in the location section and the diagnoses section of the user interface. The editor 1310 categorize these keywords into location and diagnosis-specific hierarchies, as they work their way through the ICD-10 tree, varying from or augmenting ICD-10's structure when they deem appropriate. The editor 1310 links specific location keywords with custom-defined regions of anatomical art images. For example, the ICD-10 code S72.341 “Displaced spiral fracture of shaft of right femur”, would include a links to the location keyword “Shaft of right femur”, and the diagnosis keyword “Displaced spiral fracture”, which are categorized into their respective hierarchies.

For example, Location hierarchy: Body>Limbs>Lower limb>Right lower limb>Right hip and thigh>Right thigh>Right Femur>Right femoral shaft; and

Diagnosis hierarchy: All diagnoses>Injury, poisoning and other consequence of external causes>Injuries>Fracture>Spiral fracture>Displaced spiral fracture.

After all ICD-10 codes have been linked with keywords and those keywords have been organized hierarchically, the editor allows customization of the keyword trees to ensure the more clinically relevant and accurate categorization of keywords, and to provide the richness and depth of data that will drive the keyword-based search.

Using the editor 1310, multiple levels of the keyword hierarchy are then grouped by their level of depth. The keywords themselves are shortened to only include new, relevant information specific to its level of depth (e.g., the tree branch “Arm”>“Upper arm”>“Right Upper Arm” would be shortened to this simplified branch, “Arm”>“Upper”>“Right”). These shortened “Terms” are then grouped for distinctness, with each level of depth in the hierarchy corresponding to a separate grouping of terms to be filtered on in the search.

FIG. 14 provides an example of the of how the editor 1310 would link the keywords below the diagnosis keyword “Otitis media,” based on the operation of the editor 1310 noted above. The tree structure shown in FIG. 14 can then be transformed into the term boxes shown in FIG. 15.

The editor 1310 can further customization of the boxes shown in FIG. 15 to ensure that the groupings are logically organized and clearly worded. Once the groupings are set, each ICD-10 code is assigned a set of search terms that include the keywords and all synonyms for keywords linked directly to that code, plus any defined abbreviations. Any keywords and synonyms that are ancestors of the direct links will also be associated with the keyword. For example, an ICD-10 code that had links to “Fracture” and “Femur” would also include search terms for keywords like “Injuries,” “Thigh,” “Leg,” “Hip,” and “Lower limb.” These search terms are what drive the text-based search. Once all of the data is gathered and organized, a “publish” process transforms the data into an optimized data structure for very quick searches, typically in the range of 10-300 milliseconds.

After the editor 1310 defines the keywords, linkages between keywords, and associated anatomical images.

With the search terms already in pre-processed format, a free-text search can be run against all of these terms, bringing back all billable ICD-10 codes that include search terms that start with or match each of the input words searched. For example, the search string “femur fracture” would result in the return of nearly 3,000 ICD-10 codes—any that have search terms for both words “femur” and “fracture”.

All of the diagnosis and keyword terms (shortened keywords) that are linked with all of these ICD-10 codes are grouped together in boxes that correspond to how they were organized in the editor 1310, and each is returned in its respective section of the RAD search tool, so the user can see several levels of depth worth of keywords at once, and to easily choose how to filter the long list of results.

Because the filter terms are still associated with their hierarchies derived by the editor 1310, choosing any filter will automatically limit the ICD-10 results to codes that explicitly link to that term, and will update the term lists to only include still-relevant terms.

For example, if after searching “femur fracture”, the user then selected the “spiral” (type of fracture) diagnosis keyword, all other mutually exclusive filters for types of fractures would disappear, as would all location keywords under “femur” except for “femoral shaft”, as that is the only part of the femur where a spiral fracture can occur. This one selection reduces the number of ICD-10 codes from its initial number of nearly 3,000 to 96.

With as few as four and as many as six more clicks on specific filters, the list of ICD-10 codes is reduced to one, corresponding to the very specific combination of filters the user has selected.

In addition to starting with a free-text search, the user may begin by clicking on specific regions in an anatomical picture, which will zoom in as images are available. For example, clicking on the head of an image showing a whole body will then zoom in on a large image of head; clicking on the left eye within the head will them zoom in on a large image of the eye. Once a region is clicked on that has no further zoom level in images, the location selection column will then revert to the text filters, already filtered based on the user's selections from the images. A list of applicable diagnosis filters for that specific location will then be shown, and again, with very few additional clicks a single billable ICD-10 code will result.

FIG. 16 is a block diagram of the RAD application system in accordance with an embodiment of the present invention. The RAD application system 1600 includes a memory 1601, a processor 1602, user interface 1603, RAD applications 1604, communication interface 1605, and network bus 1606.

The memory 1601 can be non-transitory computer-readable storage medium used to store executable instructions, or computer program thereon. The memory 1601 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer program” is intended to encompass an executable program that exists permanently or temporarily on any computer-readable storage medium as described above. The computer program is also intended to include an algorithm made up of executable instructions stored in the memory 1601 that are executable by a hardware processor 1602, which may be facilitated by one or more of the RAD applications 1604.

The user interface 1603 allows for interaction between a user and the RAD application system 1600. The user interface 1603 includes the Internet-based (front end) portal, wherein the portal 103 is a homepage for all the user interface elements for initiated functions of the RAD tool of the RAD application system 1600. The communication interface 1605 provides for two-way data communications to and from the RAD application system 1303 via the Internet.

The RAD applications 1604 may include, but are not limited to, an operating system or any special computer program that manages the relationship between application software and any suitable variety of hardware that helps to make-up a computer system or computing environment of the RAD application system 1600. General communication between the components of the RAD application system 1600 is provided via the bus 1606.

The communication interface 1605 may also include a digital subscriber line (DSL) card or modem, an integrated services digital network (ISDN) card, a cable modem, or a telephone modem to provide a data communication connection to a corresponding type of telephone line. As another example, communication interface 1605 may be a local area network (LAN) card (e.g., for Ethernet™ or an Asynchronous Transfer Model (ATM) network) to provide a data communication connection to a compatible LAN.

Further, the communication interface 1605 may also include peripheral interface devices, such as a Universal Serial Bus (USB) interface, a Personal Computer Memory Card International Association (PCMCIA) interface, and the like. The communication interface 1605 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown). The communication interface 1605 also allows data access between the RAD application system, the database 1304 and the editor 1310.

The operations of the RAD application system 1600 can be performed by programs stored in the memory 1601 and in the RAD applications 1604, which are executed by the hardware processor 1602 for performing the functions described with reference to FIGS. 2-12.

FIG. 17 is a block diagram of the editor in accordance with an embodiment of the present invention. The editor 1700 includes a memory 1701, a processor 1702, user interface 1703, application programs 1704, communication interface 1705, and network bus 1706.

The memory 1701 can be non-transitory computer-readable storage medium used to store executable instructions, or computer program thereon. The memory 1701 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer program” is intended to encompass an executable program that exists permanently or temporarily on any computer-readable storage medium as described above. The computer program is also intended to include an algorithm made up of executable instructions stored in the memory 1701 that are executable by a hardware processor 1702, which may be facilitated by one or more of the application programs 1704.

The user interface 1703 allows for interaction between a user and the editor 1700. The communication interface 1705 provides for two-way data communications to and from the editor 1700 via the Internet.

The application programs 1704 may include, but are not limited to, an operating system or any special computer program that manages the relationship between application software and any suitable variety of hardware that helps to make-up a computer system or computing environment of the monitoring and management apparatus 1701. General communication between the components of the editor 1700 is provided via the bus 1706.

The communication interface 1705 may also include a digital subscriber line (DSL) card or modem, an integrated services digital network (ISDN) card, a cable modem, or a telephone modem to provide a data communication connection to a corresponding type of telephone line. As another example, communication interface 1705 may be a local area network (LAN) card (e.g., for Ethernet™ or an Asynchronous Transfer Model (ATM) network) to provide a data communication connection to a compatible LAN.

Further, the communication interface 1705 may also include peripheral interface devices, such as a Universal Serial Bus (USB) interface, a Personal Computer Memory Card International Association (PCMCIA) interface, and the like. The communication interface 1705 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown). The communication interface 1705 also allows data access between the editor 1700, the RAD application system 1600, and the database 1304.

The operations of the editor 1700 can be performed by programs stored in the memory 1701 and executed by the hardware processor 1702 for performing the functions described with reference to FIGS. 14 and 15.

In an embodiment of the invention, the RAD application system 1600 and the editor 1700 include a hardware processor, a ROM, a RAM, a hard disk, a display unit, a keyboard, and a mouse. A computer program is stored in the RAM or the hard disk unit. The hardware processor operates according to the computer program, so that each device performs its corresponding function. Here, in order to perform a predetermined function, the computer program is programmed by combining instruction codes each indicating an instruction for a computer.

In another embodiment of the invention, part or all of the elements included in each device may be included in one system LSI (Large Scale Integration). The system LSI is a super-multifunctional LSI manufactured by integrating the elements on one chip, and is specifically a computer system including, for example, a micro processing unit, a ROM, and a RAM. A computer program is stored in the RAM. The micro processing unit operates according to the computer program, so that the system LSI performs its function.

Moreover, the elements included in each device may be integrated into individual chips, or into a single chip so as to include par or all of the elements.

Here, although an integrated circuit is referred to as the system LSI, the integrated circuit may also be referred to as an IC, an LSI, a super LSI, or an ultra LSI. In addition, a circuit integration method is not limited to the LSI, and may be realized with a dedicated circuit or a general-purpose processor. FPGA (Field Programmable Gate Array) that can be programmed after the manufacture of the LSI or a reconfigurable processor which can reconfigure connection or setting of circuit cells in the LSI may be used.

Additionally, if a new circuit integration technique is introduced in place of the LSI along with development in semiconductor technology or other derivative technology, it is obvious that the technique may be used for integrating functional blocks. There is a possibility of applying, for example, biotechnology.

In yet another embodiment of the invention, part or all of the elements included in each device may be included in an IC card detachable to each device or in a stand-alone module. The IC card or the module is a computer system including, for example, a micro processing unit, a ROM, and a RAM. The IC card or the module may include the super-multifunctional LSI. The micro processing unit operates according to a computer program, so that the IC card or the module performs its function.

Furthermore, in the present invention, the computer program or the digital signal may be recorded on a non-transitory computer-readable recording medium such as a flexible disk, a hard disk, a CD-ROM, a DVD, a DVD-ROM, a DVD-RAM, a BD (Blu-ray Disc), and a semiconductor memory. In addition, the present invention may be the digital signal recorded on these recording media.

Moreover, in the present invention, the computer program or the digital signal may be transmitted via an electric telecommunication line, a wireless or wired telecommunication line, a network represented by, for example, the Internet or data broadcasting.

From the description provided herein, those skilled in the art are readily able to combine software created as described with the appropriate general purpose or special purpose computer hardware for carrying out the features of the invention.

Additionally, it should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claim.

What is claimed is:

1. A method of searching for International Classification of Diseases (ICD) codes using a stand-alone web-based rapid anatomical documentation (RAD) system, the ICD codes being linked to key words that are applied to a standards-based structured vocabulary, the method comprising:
accessing the RAD system via a network connection after authentication is performed;
providing a user interface (UI) for launching an RAD tool within an RAD system environment;
launching a search request related to a search of an ICD code by making a selection within the UI;
displaying a search screen divided into a plurality of display regions, the search regions including a location section, a diagnoses section and an ICD code section;
initiating a search type from the search screen, the search type including a text search and anatomy search, the location section having a different configuration depending on the type of search selected;
entering a search request based on the type of search selected;
displaying available search filters in the location section and the diagnoses section and available ICD codes in the code section based on the entered search request;
selecting at least one search filter from the location section or the diagnosis section, which causes an update of the search filters and ICD codes available in the code section, the selection of the search filters being repeatable until a number of codes available in the codes section reaches a minimum value;
selecting at least one ICD code from the code section, each ICD code being linked to keywords hierarchically organized and associated with the search filters, links to defined regions on anatomical art images and clinically relevant information;
saving the selected ICD code and the clinically relevant information.

2. The method according to claim 1, wherein when the search type selected is an anatomy search, the method further comprising:
selecting a gender of the anatomy to be displayed in the location section;
selecting an orientation of the anatomy; and
displaying an anatomical art image that is a graphical representation of a human anatomy for the gender selected,
wherein the anatomical art image includes selectable links corresponding to regions on the human anatomy, and
the links on the anatomical art are selected to enter the search request.

3. The method according to claim 1, wherein when the search type selected is a text search, the method further comprising:
selecting a gender of the anatomy to be displayed in the location section; and
entering at least two text characters into a search field included with the plurality of display regions, which results in displaying the available search filters in the location section and the diagnoses section and available ICD codes in the code section based on the entered search request.

4. The method according to claim 1, further comprising,
switching between the search types by selecting a switch search button provided within RAD tool of the RAD system environment; and
updating the location section based on switching between the search types.

5. The method according to claim 1, wherein the saving of the search request saves search terms used, the search filters selected and codes returned and selected in association with a user account associated with the search request, and
the saved search is viewable at a future time when launching the RAD tool within the RAD system environment in association with the user account.

6. The method according to claim 5, wherein saving the results of the search request further includes pasting a URL into a messaging application or a patient chart note.

7. The method according to claim 5, wherein accessing the RAD system via a network connection requires authentication of a username and password, wherein the username and password is associated with the user account.

8. The method according to claim 1, further comprising:
displaying required fields for entering data when a code is selected in the code section

9. The method according to claim 1, wherein the displaying the clinically relevant information based on the code selected includes doctor orders, procedures, medications and billing information.

10. The method according to claim 9, wherein the codes are ICD-10 codes.

11. The method according to claim 2, further comprising displaying an enlarged view of the human anatomy based on the link selected for the anatomical art image, and updating the filters and codes available based on the link selected.

12. The method according to claim 9, further comprising:
displaying a detailed view of the keywords hierarchically organized and associated with the search filters, links to defined regions on anatomical art images and clinically relevant information based on the ICD-10 code selected.

13. A non-transitory computer-readable recording medium storing a program for searching for International Classification of Diseases (ICD) codes using a stand-alone web-based rapid anatomical documentation (RAD) system, the ICD codes being linked to key words that are applied to a standards-based structured vocabulary, the program causing a computer to perform steps comprising:
accessing the RAD system via a network connection after authentication is performed;
providing a user interface (UI) for launching an RAD tool within an RAD system environment;
launching a search request related to a search of an ICD code by making a selection within the UI;
displaying a search screen divided into a plurality of display regions, the search regions including a location section, a diagnoses section and an ICD code section;
initiating a search type from the search screen, the search type including a text search and anatomy search, the location section having a different configuration depending on the type of search selected;
entering a search request based on the type of search selected;
displaying available search filters in the location section and the diagnoses section and available ICD codes in the code section based on the entered search request;
selecting at least one search filter from the location section or the diagnosis section, which causes an update of the search filters and ICD codes available in the code section, the selection of the search filters being repeatable until a number of codes available in the codes section reaches a minimum value;
selecting at least one ICD code from the code section, each ICD code being linked to keywords hierarchically organized and associated with the search filters, links to defined regions on anatomical art images and clinically relevant information;
saving the selected ICD code and the clinically relevant information.

14. The non-transitory computer-readable recording medium according to claim 13, wherein when the search type selected is an anatomy search, the program causes the computer to perform steps comprising:
selecting a gender of the anatomy to be displayed in the location section;
selecting an orientation of the anatomy; and
displaying an anatomical art image that is a graphical representation of a human anatomy for the gender selected,
wherein the anatomical art image includes selectable links corresponding to regions on the human anatomy, and
the links on the anatomical art are selected to enter the search request.

15. The non-transitory computer-readable recording medium according to claim 13, wherein when the search type selected is a text search, the program causes the computer to perform steps comprising:
selecting a gender of the anatomy to be displayed in the location section; and
entering at least two text characters into a search field included with the plurality of display regions, which results in displaying the available search filters in the location section and the diagnoses section and available ICD codes in the code section based on the entered search request.

16. The non-transitory computer-readable recording medium according to claim 13, the program causes the computer to perform steps comprising:
switching between the search types by selecting a switch search button provided within RAD tool of the RAD system environment; and
updating the location section based on switching between the search types.

17. The non-transitory computer-readable recording medium according to claim 13,
wherein the saving of the search request saves search terms used, the search filters selected and codes returned and selected in association with a user account associated with the search request, and
the saved search is viewable at a future time when launching the RAD tool within the RAD system environment in association with the user account.

18. The non-transitory computer-readable recording medium according to claim 17, wherein saving the results of the search further includes pasting a URL into a messaging application or a patient chart note.

19. The non-transitory computer-readable recording medium according to claim 13, wherein accessing the RAD system via a network connection requires authentication of a username and password, wherein the username and password is associated with the user account.

20. The non-transitory computer-readable recording medium according to claim 13, the program causes the computer to perform steps comprising:
displaying required fields for entering data when a code is selected in the code section

21. The non-transitory computer-readable recording medium according to claim 13, wherein the displaying the clinically relevant information based on the code selected includes doctor orders, procedures, medications and billing information.

22. The non-transitory computer-readable recording medium according to claim 21, wherein the codes are ICD-10 codes.

23. The non-transitory computer-readable recording medium according to claim 14, the program causes the computer to perform steps comprising:
displaying an enlarged view of the human anatomy based on the link selected for the anatomical art image, and updating the filters and codes available based on the link selected.

24. The non-transitory computer-readable recording medium according to claim 21, the program causes the computer to perform steps comprising:
displaying a detailed view of the keywords hierarchically organized and associated with the search filters, links to defined regions on anatomical art images and clinically relevant information based on the ICD-10 code selected

25. A stand-alone web-based rapid anatomical documentation (RAD) system for searching for International Classification of Diseases (ICD) codes, the ICD codes being ICD-10 codes linked to key words that are applied to a standards-based structured vocabulary, the system comprising:
a network interface for allowing access to the RAD system after authentication is performed;
an RAD application system including a user interface (UI) for launching an RAD tool for searching for searching for ICD codes within an RAD system environment;
a plurality of databases in communication with RAD application system for storing and providing information to the RAD application system related to search filters, codes, patient orders, billing information and user account information; and
an editor in communication with the RAD application system for providing information to the RAD application system regarding a link between each ICD code searched and keywords hierarchically organized and associated with the search filters, links to anatomical art and clinically relevant information,
wherein when the RAD application system launches the RAD tool, the RAD application system is configured to perform the following:
display a search screen divided into a plurality of display regions, the search regions including a location section, a diagnoses section and an ICD code section;
allow initiation of a search type from the search screen, the search type including a text search and anatomy search, the location section having a different configuration depending on the type of search selected;
allow entry of a search request based on the type of search selected;
display available search filters in the location section and the diagnoses section and available ICD codes in the code section based on the entered search request;
select at least one search filter from the location section or the diagnosis section, which causes an update of the search filters and ICD codes available in the code section, the selection of the search filters being repeated until a number of codes available in the codes section reaches a minimum value;
selects at least one ICD code from the code section, each ICD code being linked to keywords hierarchically organized and associated with the search filters, links to defined regions on anatomical art images and clinically relevant information by the editor;
save the selected ICD code and the clinically relevant information.

26. The system according to claim 25, wherein the editor is configured to link the ICD codes to keywords, organize the keywords in hierarchies for creating keyword trees and group the keyword hierarchies.

27. The system according to claim 26, wherein the keywords are associated with links to defined regions on anatomical art images displayed in the location section when conducting an anatomy search.

28. The system accordingly to claim 26, wherein the keywords are associated with text when conducting the text search.

29. The system accordingly to claim 25, wherein the RAD application system is configured to display the clinically relevant information based on the code selected that includes doctor orders, procedures, medications and billing information.

30. The system accordingly to claim 25, wherein the RAD application system is configured to display a detailed view of the keywords hierarchically organized and associated with the search filters, links to defined regions on anatomical art images and clinically relevant information based on the ICD-10 code selected.

31. The system according to claim 26, wherein the editor is configured to divide keywords into location and diagnosis-type, and categorize the keywords into location and diagnosis-type hierarchies.

32. The system according to claim 26, wherein the editor is configured to link specific location keywords with custom-defined regions of anatomical art images.
